(19) United States
(12) Patent Application Publication
(10) Pub. No.: US 2024/0303700 A1
(43) Pub. Date: Sep. 12, 2024

(54) INTELLECTUAL PROPERTY CROWDFUNDING SYSTEM AND OPERATION METHOD THEREOF

(71) Applicants: Woo Hyuck JANG, Seoul (KR); Joon Ho LEE, Namyangju-si (KR)

(72) Inventors: Woo Hyuck JANG, Seoul (KR); Joon Ho LEE, Namyangju-si (KR)

(21) Appl. No.: 18/591,237

(22) Filed: Feb. 29, 2024

(30) Foreign Application Priority Data
Mar. 7, 2023 (KR) 10-2023-0029970

(51) Int. Cl. G06Q 30/0279; G06Q 40/06

(52) U.S. Cl. CPC G06Q 30/0279; G06Q 40/06

(57) ABSTRACT

A method of providing a design crowdfunding service for a design product in a design crowdfunding system according to an embodiment of the present disclosure may include initiating crowdfunding by exposing an image of the design product; setting an investment period for the design product; recruiting an investor by providing an expected rate of return and a real-time rate of return during the investment period; and settling, when the investment period has elapsed, an amount of profit for the crowdfunding based on a number of sales and a displayed rate of return for the design product.

### CROSS-REFERENCE TO RELATED APPLICATIONS

The present application claims the benefit of priority to Korean Patent Application No. 10-2023-0029970, filed on Mar. 7, 2023, in the Korean Intellectual Property Office. The disclosures of the above-listed application are hereby incorporated by reference herein in their entirety.

### BACKGROUND OF THE INVENTION

### Field of the Invention

The present disclosure relates to an intellectual property (IP) crowdfunding system and a method of operating the same, and more particularly, to an intellectual property (IP) crowdfunding system capable of registering, by a designer, a design to receive crowdfunding for the development, production, and the like of a design product, selecting and funding, by an investor, a design to receive a return on investment, allowing a designer who has registered a design to earn a lot of profit since there is no limit on a collection amount, and providing a refund opportunity to an investor whose rate of return decreases as the collection amount increases, and a method of operating the same.

### Background of the Related Art

Crowdfunding is a method of collecting funds, by a consumer in need of funds, from an unspecified number of people through an online platform or the like. In general, crowdfunding is a method in which a target amount is set and a project is successful if more than the target amount is collected, but if the target amount is not achieved, then the collected amount is returned to investors and the project is cancelled.

In this existing crowdfunding system, a consumer in need of funds may collect funds by setting a target amount in advance, making it difficult to earn additional profits beyond the amount needed for the development, production, and sales of his or her own design product at a collection stage, and thus there is a problem in that active funds collection activities are not carried out, the participation of a designer with high value is inevitably low, and evaluation on the product is determined based on whether or not the target amount is achieved.

Furthermore, there is a problem in providing appropriate compensation to the majority of the public who provide funds in the existing crowdfunding system, and there is a method of providing shares, dividends, or the like for appropriate compensation, but this may only be used as a method of raising funds for startup companies, or the like, and there are aspects that are inappropriate for use by individuals such as designers.

In addition, the existing crowdfunding system is only built for those who collect funds or provide funds, and thus there is an inconvenience of having to separately search for and select product producers and find separate routes to sell products.

Therefore, in order to solve the foregoing problems, the need for a design crowdfunding system capable of allowing not only a company but also an individual designer to register his or her design product to collect funds, providing a designer with surplus amounts other than costs for the development, production, and the like of a design product to allow the designer himself or herself to earn a lot of profit since there is no limit on a collection amount, providing a certain share of the proceeds from the sales price to allow an investor who has collected funds to receive a return on investment, providing refund opportunities to existing investors whenever a rate of return decreases at a certain ratio as a collection amount increases due to no limit on the collection amount, and providing a producer and a consumer of a product with an easy opportunity to produce and purchase the product, and a method of operating the same is gradually increasing.

### SUMMARY OF THE INVENTION

The present disclosure is contrived to solve the foregoing problems, and an aspect of the present disclosure is to provide a design crowdfunding system capable of allowing not only a company but also an individual designer to easily register his or her design product to collect funds, and allowing an individual designer to receive surplus amounts other than costs for the development, production, and the like of a design product from the collection amount so as to earn a lot of profit since there is no limit on a collection amount, and a method of operating the same.

In addition, an aspect of the present disclosure is to provide a design crowdfunding system capable of providing refund opportunities to existing investors based on a displayed rate of return, and distributing a difference in an amount of profit due to a refund of an existing investor to a designer, an investor, a producer, an operator, and the like to generate a fair and high profit, and a method of operating the same.

Technical problems of the present disclosure are not limited to the above-mentioned problems, and other technical problems which are not mentioned herein will be clearly understood by those skilled in the art from the description below.

In order to solve the foregoing technical problems, a method of providing a design crowdfunding service for a design product in a design crowdfunding system according to an embodiment of the present disclosure may include initiating crowdfunding by exposing an image of the design product; setting an investment period for the design product; recruiting an investor by providing an expected rate of return and a real-time rate of return during the investment period; and settling, after the investment period has elapsed, an amount of profit for the crowdfunding based on a number of sales and a displayed rate of return for the design product. The real-time rate of return may be calculated by dividing a value obtained by subtracting a production price from a sales price of the design product by a total investment amount of the existing investor, the expected rate of return may be calculated by dividing a value obtained by subtracting the production price from the sales price of the design product by a sum of the total investment amount and an expected investment amount of an additional investor, and the displayed rate of return may be calculated as the real-time rate of return at the time of funding or refunding by the investor.

A design crowdfunding system and a method of operating the same according to the present disclosure may allow not only a company but also an individual designer to easily register his or her design product to collect funds, and allow an individual designer to receive surplus amounts other than costs for the development, production, and the like of a design product from the collection amount so as to earn a lot of profit since there is no limit on a collection amount.

In addition, a design crowdfunding system and a method of operating the same according to the present disclosure may provide refund opportunities to existing investors based on a displayed rate of return, and distribute a difference in an amount of profit due to a refund of an existing investor to a designer, an investor, a producer, an operator, and the like to establish a fair profit amount settlement system.

### BRIEF DESCRIPTION OF THE DRAWINGS

In order to more fully understand the drawings cited in the detailed description of the present disclosure, a brief description of each drawing is provided.

FIG. 1 is a schematic block diagram for explaining a design crowdfunding system 10 according to an embodiment of the present disclosure.

FIG. 2 is a schematic block diagram for explaining a design crowdfunding server 100 in FIG. 1.

FIG. 3 is a schematic block diagram for explaining an investor support module 130 in FIG. 2.

FIG. 4 is a schematic block diagram for explaining a settlement module 160 in FIG. 2.

FIG. 5 is a flowchart for explaining a method of operating the design crowdfunding system 10 according to an embodiment of the present disclosure.

FIG. 6 is a flowchart for explaining step S140 of FIG. 5.

FIG. 7 is a flowchart for explaining step S150 of FIG. 5.

FIGS. 8A and 8B are examples for explaining when an additional investor is introduced in step S152 of FIG. 7.

FIG. 9 is a flowchart for explaining step S180 of FIG. 5.

### DESCRIPTION OF SYMBOLS

10: Design crowdfunding system

100: Design crowdfunding server

200: Designer terminal

300: Producer terminal

400: Investor terminal

500: Consumer terminal

### DETAILED DESCRIPTION OF THE PREFERRED EMBODIMENT

Hereinafter, embodiments of the present disclosure will be described clearly and in detail so that those skilled in the art may easily practice the present disclosure. However, the present disclosure may be implemented in various different forms within the scope described in the claims, and thus the embodiments which will be described below are merely exemplary regardless of expressions thereof. That is, the present disclosure is not limited to the embodiments which will be disclosed below, but may also be implemented in various different forms.

It should be noted that the terms used herein are merely used to describe a specific embodiment, but not to limit the present disclosure. As used herein, the singular forms are intended to include the plural forms as well, unless the context clearly indicates otherwise. Terms “include” or “have” used herein should be understood that they are intended to indicate the existence of a feature, a number, a step, a constituent element, a component or a combination thereof disclosed in the specification, and it may also be understood that the existence or additional possibility of one or more other features, numbers, steps, constituent elements, components or combinations thereof are not excluded in advance.

Although terms of “first,” “second,” and the like are used to explain various components, the components are not limited to such terms. The terms are used merely for the purpose to distinguish an element from the other element.

Hereinafter, embodiments of the present disclosure will be described as follows with reference to the accompanying drawings.

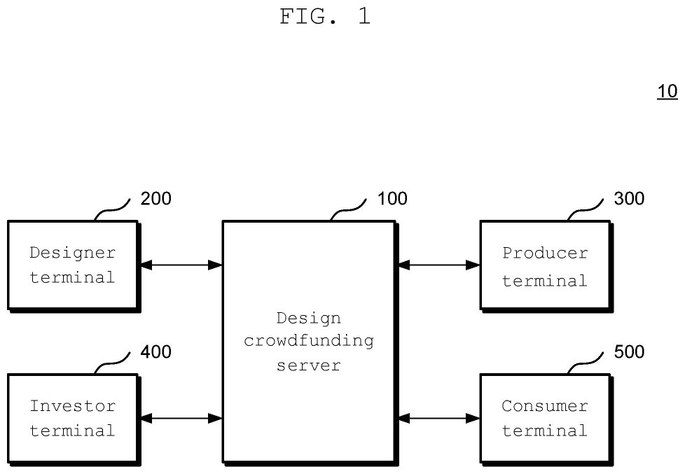

FIG. 1 is a schematic block diagram for explaining a design crowdfunding system 10 according to an embodiment of the present disclosure.

As shown in FIG. 1, the design crowdfunding system 10 according to an embodiment of the present disclosure may include a design crowdfunding server 100, a designer terminal 200, a producer terminal 300, an investor terminal 400, and a consumer terminal 500. The design crowdfunding server 100 may be communicatively coupled to the designer terminal 200, the producer terminal 300, the investor terminal 400, and the consumer terminal 500.

The design crowdfunding system 10 may provide a design crowdfunding service that mediates crowdfunding for a design product. It may be understood that the design product includes a product or service to which a design created by a creator has been applied, wherein the design includes not only the form, shape, color of a commodity, or a combination thereof, but also a copyrighted work, a trademark, a patent, a utility model, or the like (intellectual property). Hereinafter, in the specification, a design is illustrated as a copyrighted work such as a character, and a design product is illustrated as a product to which a character is applied, but the design and design product are not limited thereto.

The design crowdfunding server 100 may be configured to mediate a design crowdfunding service in connection with the designer terminal 200, the producer terminal 300, the investor terminal 400, and the consumer terminal 500. The design crowdfunding server 100 may correspond to a device based on its own computer program produced and operated by an individual or private company, and may be referred to by a term such as a device, an equipment, a computer, a cloud, a platform, and an application, depending on various expressions in the technical field related thereto.

The design crowdfunding server 100 may communicate with the designer terminal 200 to register the creator's design or design product. The designer terminal 200 may register a design such as a character on the design crowdfunding server 100 based on the creator's input signal. According to an embodiment, the designer terminal 200 may register a design product, such as a product to which a character is applied, to the design crowdfunding server 100 based on the creator's input signal.

The design crowdfunding server 100 may communicate with the producer terminal 300 to determine a design product. The designer terminal 200 and the producer terminal 300 may communicate through the design crowdfunding server 100 and determine a design product (or an image for the design product) to be exposed to the investor terminal 400 and the consumer terminal 500. For example, a design registered through the designer terminal 200 may be combined with a product by the producer terminal 300 and provided back to the designer terminal 200, and an image of the design product finally determined by the designer terminal 200 may be exposed to the investor terminal 400 and the consumer terminal 500 through the design crowdfunding server 100. According to an embodiment, the design product registered through the designer terminal 200 may be modified by the producer terminal 300 and provided back to the designer terminal 200.

The design crowdfunding server 100 may communicate with the investor terminal 400 to recruit an investor for the design product. The design crowdfunding server 100 may provide a real-time rate of return for the design product to the investor terminal 400, thereby recruiting an investor through the investor terminal 400. The investor terminal 400 may execute an investment in the selected design product by selecting a design product and entering an investment amount based on the investor's input signal.

The design crowdfunding server 100 may communicate with the producer terminal 300 and the consumer terminal 500 to mediate the production and sale of the design product. For example, the design crowdfunding server 100 may transmit a production request for the design product to the producer terminal 300. For example, the design crowdfunding server 100 may transmit a sale availability message for the design product to the consumer terminal 500 and receive a purchase request for the design product from the consumer terminal 500.

The designer terminal 200, the producer terminal 300, the investor terminal 400, and the consumer terminal 500 may also be referred to as a subscriber unit, a subscriber station, a mobile station, a mobile terminal, a remote station, a remote terminal, a mobile device, an access terminal, a wireless communication device, a user agent, a user device, or a user equipment (UE). The access terminal may be another processing device connected to a cellular phone, a cordless phone, a session initiation protocol (SIP) phone, a wireless local loop (WLL) station, a personal digital assistant (PDA), a handheld device with wireless connectivity capability, a computing device, or a wireless modem.

According to an embodiment, the designer terminal 200, the producer terminal 300, the investor terminal 400, and the consumer terminal 500 may be simply classified according to whether he or she is a designer, producer, investor, or consumer using the design crowdfunding server 100, and thus may be the same device, different devices, or multiple devices.

According to an embodiment, although it is described throughout the specification that the design crowdfunding system 10 is configured such that a designer may register a design to receive funding, an investor may also fund a design, and a producer and a consumer may also produce or purchase a design product, this is just an example for easy understanding of the present disclosure, and may also be similarly applied to not only the design but also an intangible right, such as a patent, a utility model, and a copyright.

In addition, a design product produced by a producer or purchased by a consumer through the design crowdfunding system 10 may include a tangible movable asset that is subject to an independent transaction produced by applying the design, and profits earned from registration by a designer or funding by an investor may include not only a profit from selling a tangible movable asset that is subject to an independent transaction produced by applying the design, but also all profits generated from commercial activities using the design.

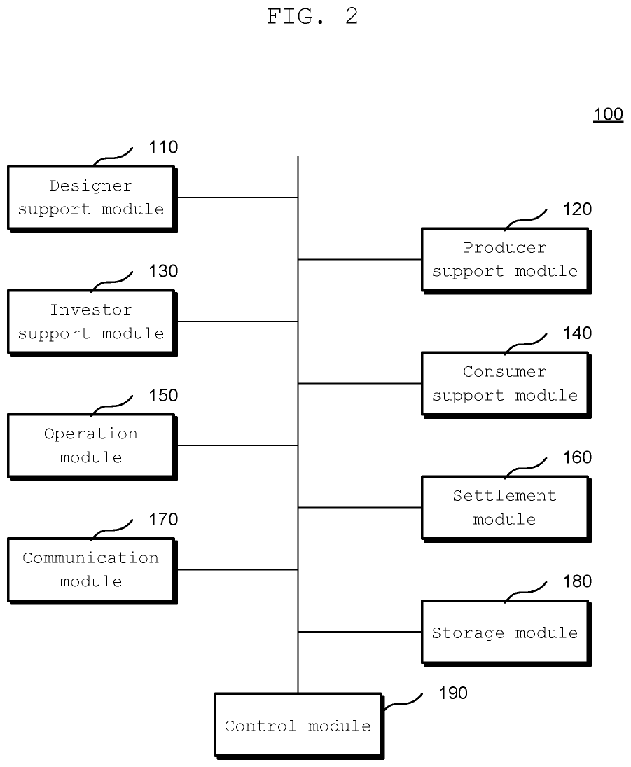

FIG. 2 is a schematic block diagram for explaining a design crowdfunding server 100 in FIG. 1. The design crowdfunding server 100 may include a designer support module 110, a producer support module 120, an investor support module 130, a consumer support module 140, an operation module 150, a settlement module 160, a communication module 170, a storage module 180, and a control module 190.

The elements 110, 120, 130, 140, 150, 160, 170, 180, 190 of the design crowdfunding server 100 shown in FIG. 2 are merely illustrative elements for explaining the operation, function, and the like of the design crowdfunding server 100 according to an embodiment of the present disclosure. That is, it is apparent that the design crowdfunding server 100 additionally includes other elements (e.g., a power module, etc.) other than the illustrated elements 110, 120, 130, 140, 150, 160, 180, 190.

The designer support module 110 may be configured to register a design or design product. The designer support module 110 may receive an image of a design or design product through the designer terminal 200, and register the received image as a funding product along with a description of the design or design product.

The designer support module 110 may be communicatively coupled to the designer terminal 200 through the communication module 170, and may be configured to allow a user of the designer terminal 200 to use the design crowdfunding server 100.

Specifically, the designer support module 110 may communicate with the designer terminal 200 through the communication module 170 so that the user of the designer terminal 200, that is, the designer, can use the design crowdfunding system 10 according to the present disclosure through the designer support module 110.

According to an embodiment, the designer support module 110 may be configured to pay a design profit to the designer who registered a design or design product, and may also be configured to change a sales price of the design. Here, the term ‘design profit’ may be understood to refer to all profits paid to the designer who registered the design out of a total amount collected through funding. In addition, a designer may be defined as a concept that includes all people who created a design, a person who created a design and registered it on the design crowdfunding server 100, and may of course include a person who owns the rights not only to a design, but also to a patent, a utility model, a trademark, a copyrighted work, or the like.

The producer support module 120 may be configured to connect a registered design or design product to a producer. The producer support module 120 may be communicatively coupled to the producer terminal 300 through the communication module 170, and the user of the producer terminal 300 may be configured to use the design crowdfunding server 100.

Specifically, the producer support module 120 may communicate with the producer terminal 300 through the communication module 170 so that the user of the producer terminal 300, that is, the producer, can use the design crowdfunding system 10 according to the present disclosure through the producer support module 120.

According to an embodiment, the producer support module 120 may provide a registered design to the producer terminal 300 and receive an image for a design product through the producer terminal 300. That is, a design registered through the designer support module 110 may be changed into a design product for funding through the producer support module 120. For example, the producer terminal 300 may select a design that can be produced among registered designs based on the producer's input signal, and generate an image for a design product, and provide the generated image to the producer support module 120. In this case, the producer support module 120 and the designer support module 110 may modify or supplement the image for the design product to generate an image for a design product that will ultimately be funded.

According to an embodiment, when content registered through the designer support module 110 is a design product, the producer support module 120 may receive an expected production image of the registered design product through communicating with the producer terminal 300, and funding may be initiated based on the image.

The investor support module 130 may be configured to proceed with funding based on the design product determined by the designer support module 110 and the producer support module 120. For example, the investor support module 130 may be configured to set an investment period and recruit an investor within the investment period. The investor support module 130 may be communicatively coupled to the investor terminal 400 through the communication module 170, and the user of the investor terminal 400 may be configured to use the design crowdfunding server 100.

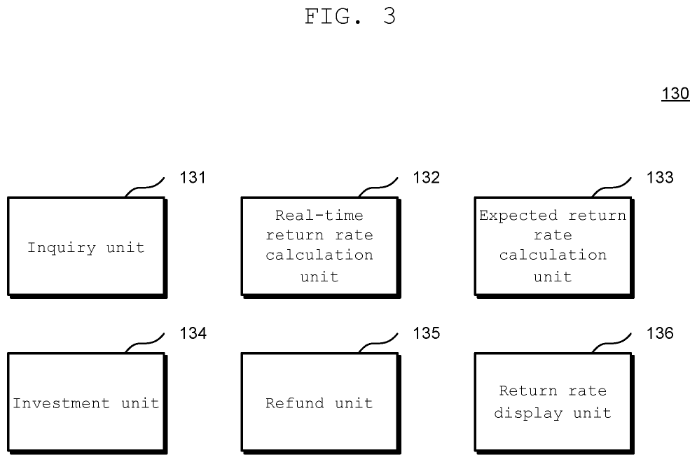

Specifically, the investor support module 130 may communicate with the investor terminal 400 so that the user of the investor terminal 400, that is, the investor, can use the design crowdfunding system 10 according to the present disclosure through the investor support module 130. In addition, the investor support module 130 may be configured to allow the investor to select and fund a design product. A detailed description of the investor support module 130 will be described later in FIG. 3.

The consumer support module 140 may be configured to display product information about a design product and proceed with a purchase procedure. The consumer support module 140 may be communicatively coupled to the consumer terminal 500 through the communication module 170, and the user of the consumer terminal 500 may be configured to use the design crowdfunding server 100.

Specifically, the consumer support module 140 may communicate with the consumer terminal 500 through the communication module 170 so that the user of the consumer terminal 500, that is, the consumer, can use the design crowdfunding system 10 according to the present disclosure through the consumer support module 140.

The operation module 150 may be configured to provide various services necessary to operate the design crowdfunding system 10, such as producer certification, legal support, inventory management, product registration, and operation profit generation. According to an embodiment, the operation module 150 may include a mileage operation module configured to convert goods with a monetary value, such as amount, cost, or money, provided from designers, investors, producers, consumers, and the like, or provided to designers, investors, producers, consumers, and the like, into a mileage or convert a mileage into goods with a monetary value.

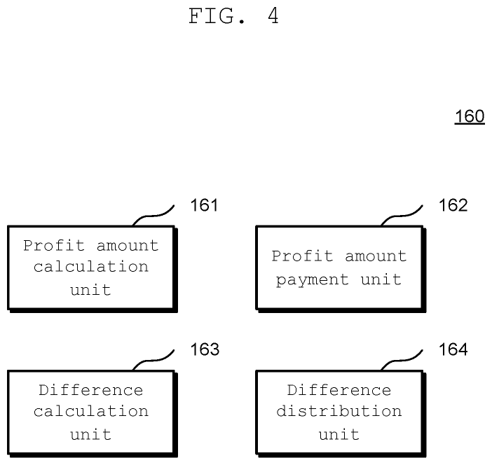

The settlement module 160 may be configured to settle investment returns. For example, the settlement module 160 may calculate an amount of profit when funding is completed and distribute the calculated amount of profit to investors and designers. According to an embodiment, the settlement module 160 may calculate and distribute a difference when a refund opportunity is provided to the investor according to a specific condition during funding. Here, the difference may be a surplus amount of profit resulting from the difference between an actual rate of return and a rate of return displayed to an additional investor. The difference may be configured to be distributed to at least one of the designer, the producer, the investor, and the operator. A detailed description of the settlement module 160 will be described later in FIG. 4.

The communication module 170 may be configured to transmit and receive data with external devices such as the designer terminal 200, the producer terminal 300, the investor terminal 400, and the consumer terminal 500. The communication module 170 is provided for direct connection to the outside or connection through a network, and may be a wired and/or wireless communication module.

Specifically, the communication module 170 may transmit data from the designer support module 110, the producer support module 120, the investor support module 130, the consumer support module 140, the operation module 150, the settlement module 160, the storage module 180, and the control module 190 in a wired or wireless manner, or receive data from the outside in a wired and wireless manner to transmit the received data to the designer support module 110, the producer support module 120, the investor support module 130, the consumer support module 140, the operation module 150, the settlement module 160, and the control module 190, or store the received data in the storage module 180. The data may include content such as text, images, and moving pictures.

According to an embodiment, the communication module 170 may perform communication through LAN, Wideband Code Division Multiple Access (WCDMA), Long Term Evolution (LTE), Wireless Broadband Internet (WiBro), Radio Frequency (RF) communication, and Wireless LAN, Wireless Fidelity (Wi-Fi), Near Field Communication (NFC), Bluetooth, and infrared communication. However, this is illustrative, and various wired and wireless communication technologies applicable in the technical field may be used according to an embodiment to which the present disclosure is applied.

According to an embodiment, the design crowdfunding server 100 may include the storage module 180 configured to store data transmitted and received by each component of the design crowdfunding server 100, that is, the designer support module 110, the producer support module 120, the investor support module 130, and the consumer support module 140, the operation module 150, the communication module 170, or the control module 190 to and from external devices such as the designer terminal 200, the producer terminal 300, the investor terminal 400, and the consumer terminal 500.

In the storage module 180, data on a design registered by a designer and information related to the design, a sales price of the registered design, a minimum production quantity, a funding period, an input refund reference value, a minimum collection amount calculation method, an investor voting method, a successful bid price, a design fee calculation method, an item of design, a funded amount and mileage, investment information related to a registered design, a rate of return, a rate-of-return calculation method, a refund amount calculation method, a refund amount paid, an investment return calculation method, a return on investment paid, an item that can be produced, production information, proposed producer information, sold product information, a product purchase history, a mileage provided, a mileage operation method, a legal support method, an active/inactive mileage, and the like may be stored.

According to an embodiment, the storage module 180 may be implemented, as known to those skilled in the art, with various type of storage devices capable of inputting and outputting information, such as a hard disk drive (HDD), a read only memory (ROM), a random access memory (RAM), an electrically erasable and programmable read only memory (EEPROM), a flash memory, a compact flash (CF) card, a secure digital (SD) card, a smart media (SM) card, a multimedia card (MMC), or a memory stick, and may be provided inside the design crowdfunding server 100 as shown in FIG. 2, or may be provided in a separate external device. Alternatively, the storage module 180 may be replaced with a web storage that performs a storage function on the Internet.

The control module 190 may be configured to control the operations, functions, and the like of the elements 110, 120, 130, 140, 150, 160, 170, 180 constituting the design crowdfunding server 100. In addition, the control module 190 may be configured to control the operations, functions, and the like of the elements 110, 120, 130, 140, 150, 160, 170, 180 according to a command received from the designer terminal 200, the producer terminal 300, the investor terminal 400, and the consumer terminal 500 through the communication module 170.

According to an embodiment, the control module 190 may be implemented with a processor, a microprocessor, a controller, microcontroller, or the like.

FIG. 3 is a schematic block diagram for explaining an investor support module 130 in FIG. 2. The investor support module 130 may include an inquiry unit 131, a real-time return rate calculation unit 132, an expected return rate calculation unit 133, an investment unit 134, a refund unit 135, and a return rate display unit 136.

The inquiry unit 131 may be configured to provide investment information on a design product registered through the investor support module 130. For example, investment information may include a sales price, a minimum production quantity, a funding period, a required investment amount, a total investment amount, a real-time rate of return, an expected rate of return, a development cost, and the like of the registered design product. The inquiry unit 131 may provide an investor with information necessary for investment by providing investment information to the investor terminal 400. The investor terminal 400 may select a design product to invest in based on investment information.

The real-time return rate calculation unit 132 may be configured to calculate a real-time rate of return for the registered design product. The rate of return may be calculated by dividing a value obtained by subtracting a production price from a sales price of the design product by a total current investment amount. According to an embodiment, the rate of return may be calculated by multiplying a value obtained by subtracting a production price from a sales price of the design product by a minimum production quantity, and then dividing it by a total current investment amount. However, the method of calculating the rate of return may not be limited thereto, and may also be defined as various methods of calculating the amount of profit compared to the investment amount.

For example, in the case of calculating a real-time rate of return, if the sales price of a currently funded design is 10,000 won, the production price is 6,000 won, and the total current investment amount is 6 million won, then an amount obtained by subtracting the production price of 6,000 won from the sales price of 10,000 won is 4,000 won, and thus approximately 0.07%, which is a value obtained by dividing the amount by the total current investment mileage of 6 million won and converting it to a percentage, may be calculated as the real-time rate of return.

The expected return rate calculation unit 133 may be configured to calculate an expected rate of return for the registered design product. The expected rate of return may refer to a rate of return when additional investment amount is added through additional funding in the real-time rate of return. The expected rate of return may follow various return rate calculation methods as described above, and may be calculated based on a total amount obtained by adding an expected investment amount entered through the investor terminal 400 to a total current investment amount. According to an embodiment, the expected rate of return may be calculated by dividing a value obtained by subtracting the production price from the sales price of the design product by the total amount.

For example, in the case of calculating an expected rate of return, if the sales price of a funded design is 10,000 won, the production price is 6,000 won, the total current investment amount is 6 million won, and the expected investment amount of an additional investor is 1 million won, then an amount obtained by subtracting the production price of 6,000 won from the sales price of 10,000 won is 4,000 won, and thus approximately 0.06%, which is a value obtained by dividing the amount by 7 million won, which is a sum of the total current investment amount of 6 million won and the expected investment amount of 1 million won, and converting it to a percentage, may be calculated as the expected rate of return.

The expected investment amount and the expected rate of return through the expected return rate calculation unit 133 are for the investor's funding convenience and are not reflected in an actual rate of return. The investor may enter an expected investment amount through the investor terminal 400, and determine an actual investment amount by referring to an expected rate of return. However, the actual rate of return may be different from the expected rate of return, and the real-time rate of return changes in real time, so in this case, the design crowdfunding system 10 according to the present disclosure may provide a service for refunding an investment amount for investor protection.

The rate of return calculated by the return rate calculation unit 132 according to an embodiment of the present disclosure may be calculated by dividing a value obtained by subtracting the production price from the sales price of the funded design by a total investment mileage, and the calculated rate of return may decrease as the total investment mileage increases since there is no limit in the total investment mileage. The higher the value of the funded design, the greater the total investment mileage by many investors, which lowers the rate of return, but an expected sales volume of the funded design may be high, so despite the low rate of return, the investor may expect a lot of profit, and whenever the rate of return falls by a reference rate of return decline value, the refund unit 135 may allow the investor to select whether to refund the investment amount and receive the refund amount.

The real-time rate of return and/or the expected rate of return calculated by the return rate calculation unit 132 and the expected return rate calculation unit 133 may be provided to the investor terminal 400 through the inquiry unit 131. Therefore, the investor may determine whether to fund, an amount of funding, and the like by receiving investment information such as the real-time or predicted rate of return of a funded design product.

The investment unit 134 may be configured to select a design product among registered design products according to an investor's request for selection and fund in the selected design product according to the amount of funding received from the investor terminal 400. The investment unit 134 may provide a list of design products available for funding to the user of the investor terminal 400, that is, the investor, and may be configured to select a design product according to the investor's input signal received through the communication module 170.

According to an embodiment, the investment unit 134 may be configured to provide an input window for entering the amount of funding to the user of the investor terminal 400, that is, the investor, and may be configured to fund in the registered design according to the entered amount of funding received from the investor through the communication module 170. That is, the investor may select and fund in a design product to be funded among design products registered through the investment unit 134. Since there is no limit to the amount of funding, that is, a total investment amount according to the present disclosure, the investment unit 134 may be configured to fund in the selected design product with no limitation according to the entered amount of funding.

The higher the value of the funded design product, the larger the total investment amount by many investors, which lowers the rate of return, but an expected sales volume of the funded design may be high, so despite the low rate of return, the investor may expect a lot of profit. However, since the rate of return itself is an important factor for an investor seeking a high rate of return with a small investment, the refund unit 135 may be configured to provide a refund opportunity to the investor.

The refund unit 135 may be configured to provide an investor with a refund opportunity for an investment amount funded in the design product through the investment unit 134. For example, whenever the real-time rate of return decreases below a reference rate of return for each section, the refund unit 135 may provide the investor terminal 400 with a selection message regarding whether to refund the investment amount.

Upon receiving a signal of consent regarding whether to refund through the investor terminal 400, the refund unit 135 may calculate a refund amount to refund the calculated refund amount to the investor. The refund amount may be calculated based on a rate of return. For example, if the real-time rate of return is 5% at the initiation of funding by a first investor, and the real-time rate of return is lowered to 4% due to the influx of an additional investor, then the refund unit 135 may provide the first investor with a refund opportunity equal to the smaller of the cost equivalent to the amount that increases the real-time rate of return to 5% and the investment amount of the first investor. According to an embodiment, an amount deducted by a commission fee may be provided to the investor upon refund.

According to an embodiment, if the real-time rate of return through refund is lower than the expected rate of return of the first investor (real-time rate of return at the initiation of funding of the first investor), then a method of calculating the amount of refund may be changed.

The refund unit 135 may divide the rate of return into a plurality of sections, for example, a first section with a rate of return above 100%, a second section with a rate of return above 10% and below 100%, a third section with a rate of return above 1% and below 10%, a fourth section with a rate of return above 0.1% and below 1%, a fifth section with a rate of return above 0.01% and below 0.1%, and a sixth section with a rate of return below 0.01%.

The refund unit 135 may set the reference rate of return for each section to 100% in the first section. That is, when the real-time rate of return is above 100%, the refund unit 135 may provide a selection message (for example, a question-and-answer message regarding a refund of the investment amount) to the investor terminal 400 about whether to refund the investment amount whenever the rate of return is decreased by 100%. For example, when the rate of return at the time of the first investor's initial investment is 300%, if the real-time rate of return due to the influx of an additional investor decreases below 200%, then the refund unit 135 may provide a message of inquiring of the first investor about whether to refund the initial investment.

The reference rate of return for each section in the second section may be set to 10%, the reference rate of return for each section in the third section to 1%, the reference rate of return for each section in the fourth section to 0.1%, the reference rate of return for each section in the fifth section to 0.01%, and the reference rate of return for each section in the sixth section to 0.001%. Hereinafter, the refund inquiry operation in the second to sixth sections is similar to the first section, and thus a detailed description thereof will be omitted.

The number of return rate sections described above, the rate of return for each section, and the reference rate of return for each section are only examples to help understand the present disclosure and may vary depending on the embodiment.

According to an embodiment, the refund unit 135 may not provide a refund opportunity for a set specific section. For example, the refund unit 135 may not provide a selection message regarding whether to refund for the fifth section and the sixth section. As a result, the investor may be protected from the outflow of a large amount of investment fund through a refund when the real-time rate of return decreases below a determined rate of return.

The return rate display unit 136 may provide a displayed rate of return displayed on the investor terminal 400. The displayed rate of return may refer to the real-time rate of return at the time of funding or refunding by the investor through the investor terminal 400. For example, when the first investor's real-time rate of return upon initial investment is 8%, the first investor's displayed rate of return may be 8%. Here, when a second investor is introduced and the real-time rate of return decreases to 5%, the second investor's displayed rate of return may be 5%. As shown in the foregoing example, the reference rate of return for each section of the section may be 1%, and in this case, the first investor may be provided with a refund opportunity. If the first investor wishes to return to an original displayed rate of return, then he or she may select a refund to maintain the first investor's displayed rate of return at 8%. However, if the first investor does not select a refund, then the first investor's displayed rate of return may also be changed to 5%.

Additionally, the displayed rate of return may be a rate of return for settlement. The displayed rate of return may vary according to the influx of an additional investor and whether to refund, and finally, settlement may be made according to the displayed rate of return. That is, the displayed rate of return may be regarded as an expected rate of return at the time of adding an amount of investment, and the settlement module 160 may determine whether a refund service has been provided through each investor's displayed rate of return, and enter, based thereon, a settlement procedure for payment of the amount of profit and distribution of the difference.

FIG. 4 is a schematic block diagram for explaining a settlement module 160 in FIG. 2. The settlement module may include a profit amount calculation unit 161, a profit amount payment unit 162, a difference calculation unit 163, and a difference distribution unit 164.

The profit amount calculation unit 161 may be configured to calculate an amount of the investor's investment profit. Funding whose investment period has expired may lead to production and sales through the producer support module 120 and the consumer support module 140, and the profit amount calculation unit 161 may acquire information on the sales quantity from the consumer support module 140 to calculate a return on investment. For example, the profit amount calculation unit 161 may be configured to calculate a return of investment by multiplying a value obtained by multiplying the sales price by the sales quantity by a rate of return, and further multiplying a value obtained by dividing an investment amount for each investor by a total investment amount.

For example, when the sales price is 10,000 won, the sales quantity is 1,000 units, the rate of return is 0.1%, the first investor's investment amount is 3 million won, and the total investment amount is 10 million won, the sales price is 10,000 won and the sales quantity is 1,000 units, an amount, which is 3,000 won, obtained by multiplying a value, which is 10,000 won, obtained by multiplying the sales price of 10,000 won by the sales quantity of 1,000 units by a rate of return 0.1%, and further multiplying a value, which is 0.3, obtained by dividing the investment mileage of 3 million won by the total investment amount of 10 million won may be calculated as the amount of investment return.

The profit amount payment unit 162 may be configured to pay the amount of profit calculated from the profit amount calculation unit 161 to the investor. For example, the profit amount payment unit 162 may remit the amount of profit to the investor's account linked to the investor terminal 400. In this case, an amount obtained by deducting transaction and remittance fees from the amount of profit may be remitted. According to an embodiment, the investment amount may be converted into a mileage usable in the design crowdfunding system according to the present disclosure, and the amount of profit may be paid as a mileage to the user of the investor terminal 400, that is, the investor. In this case, transaction and remittance fees may not be incurred.

The difference calculation unit 163 may be configured to calculate a difference according to a refund when the refund occurs. The difference calculation unit 163 may determine whether the rate of return is inconsistent, and calculate a difference when the rate of return is inconsistent. Here, the rate of return refers to a displayed rate of return, and the difference refers to a surplus amount generated due to a difference between the displayed rate of return and an actual rate of return.

For example, when the first investor is investing with a displayed rate of return of 6%, if the second investor is introduced with a displayed rate of return of 5%, then a refund opportunity may be provided to the first investor. At this time, even when the first investor agrees to a refund and maintains the displayed rate of return of 6%, the displayed rate of return may be maintained at 5% because the second investor joined the funding with the displayed rate of return of 5%. When funding is completed in this way, a difference may occur between the actual rate of return and the second investor's displayed rate of return, and a difference may occur between the total amount of profit and the distribution amount of profit when calculating the actual amount of profit. This is called a surplus amount.

The difference distribution unit 164 may be configured to distribute the difference or surplus amount to at least one of the designer, producer, investor, and operator according to a distribution policy. For example, the distribution policy may activate the influx of designers by allowing the difference distribution unit 164 to distribute a predetermined amount of the difference to the designers. According to an embodiment, the distribution policy may cause the difference distribution unit 164 to distribute the difference to an investor whose displayed rate of return and actual rate of return are different, thereby allowing the additional investor to receive a profit higher than the expected rate of return. According to an embodiment, the distribution policy may cause the difference distribution unit 164 to distribute the difference to the operator, thereby increasing a profit from operating the design crowdfunding service according to the present disclosure. It is apparent that the distribution policy is not limited thereto and may vary depending on the embodiment.

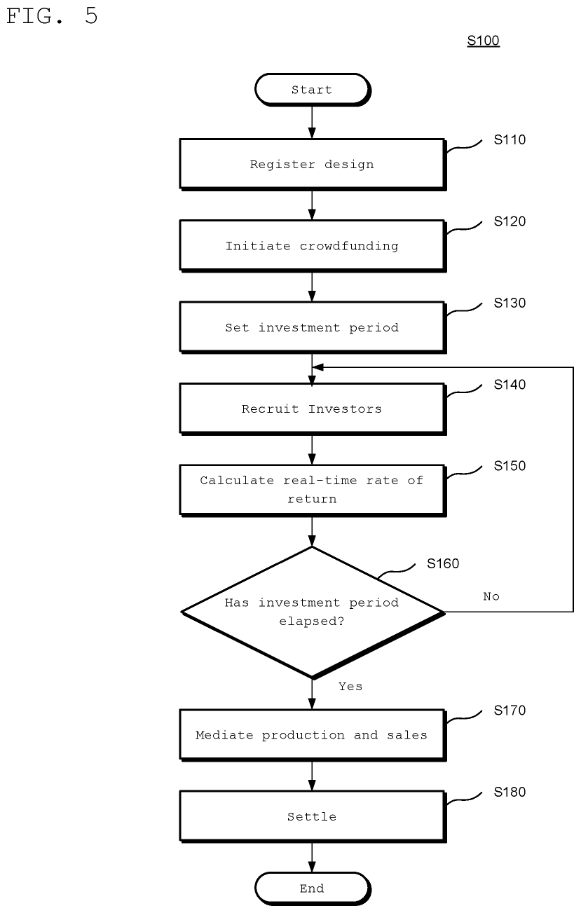

FIG. 5 is a flowchart for explaining a method of providing a design crowdfunding service for a design product in the design crowdfunding system 10 according to an embodiment of the present disclosure. The method of providing the design crowdfunding service described below may be understood that the design crowdfunding system 10 or the design crowdfunding server 100 is hosted and operated.

In step S110, the design crowdfunding system 10 may register a design or design product on the design crowdfunding server 100. For example, the designer terminal 200 may register an image of a design or design product on the design crowdfunding server 100.

In step S120, the design crowdfunding system 10 may initiate funding for the design product. Specifically, the design crowdfunding server 100 may communicate with the producer terminal 300 for the registered design or design product to select the producer, thereby determining the design product for initiating funding, and exposing the image of the determined design product to initiate crowdfunding. According to an embodiment, in step S120, the designer terminal 200 and the producer terminal 300 may determine a mock-up image or prototype image for the design product as an image of the design product for the initiation of funding.

In step S130, the design crowdfunding system 10 may set an investment period for the design product. For example, the design crowdfunding server 100 may communicate with the designer terminal 200 or the producer terminal 300 to set a period of crowdfunding, that is, an investment period.

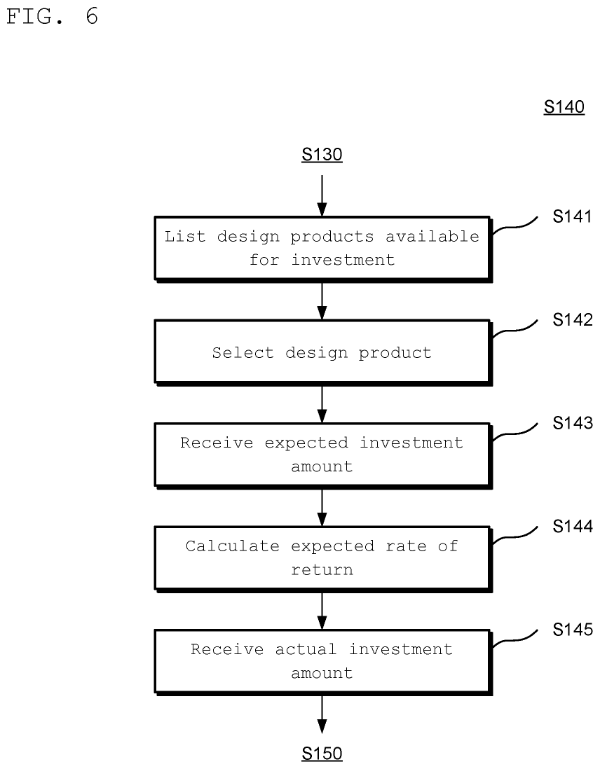

In step S140, the design crowdfunding system 10 may recruit an investor during the set investment period. For example, the design crowdfunding server 100 may attract investment amounts from the investor by providing an expected rate of return for the design product during the investment period. The investor may check the expected rate of return through the investor terminal 400 and participate in crowdfunding by selecting the design product to be funded and selecting the investment amount (or funding amount). A detailed description of S140 will be described later in FIG. 6.

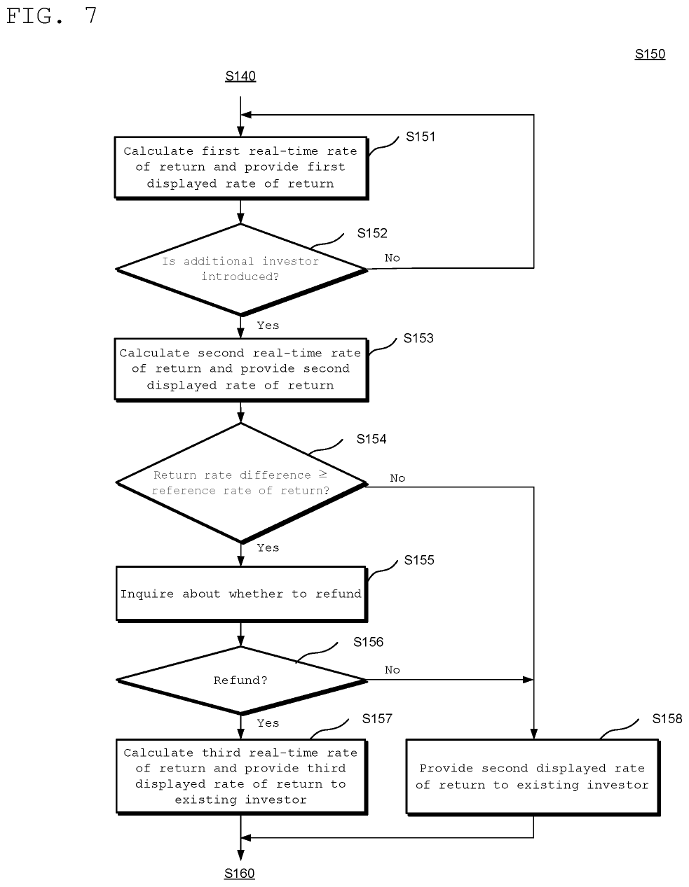

In step S150, the design crowdfunding system 10 may calculate a real-time rate of return. The real-time rates of return may also be provided to the investor terminal 400 and used for the influx of an investor. For example, the design crowdfunding server 100 may calculate the real-time rate of return by dividing a value obtained by subtracting the production price from the sales price of the design product by the investor's total investment amount. Meanwhile, the expected rate of return may be calculated by dividing a value obtained by subtracting the production price from the sales price of the design product by a sum of the total investment amount and an expected investment amount of an additional investor. A detailed description of S150 will be described later in FIG. 7.

In step S160, the design crowdfunding system 10 may determine whether the set investment period has elapsed. If the investment period has not elapsed, then the design crowdfunding system 10 may provide the expected rate of return and real-time rate of return to the investor terminal 400 to continuously recruit an investor as in step S140.

If the investment period has elapsed, in step S170, then the design crowdfunding system 10 may mediate a production and sales procedure for the funded design product. The mediation of the production procedure for the design product may mean that the design crowdfunding server 100 requests the producer terminal 300 to produce an actual product according to a set quantity. The mediation of the sales procedure for the design product may mean that the design crowdfunding server 100 provides information on the actual product to the consumer terminal 500 to induce sales. According to an embodiment, step S170 may be performed together with steps S140 to S160.

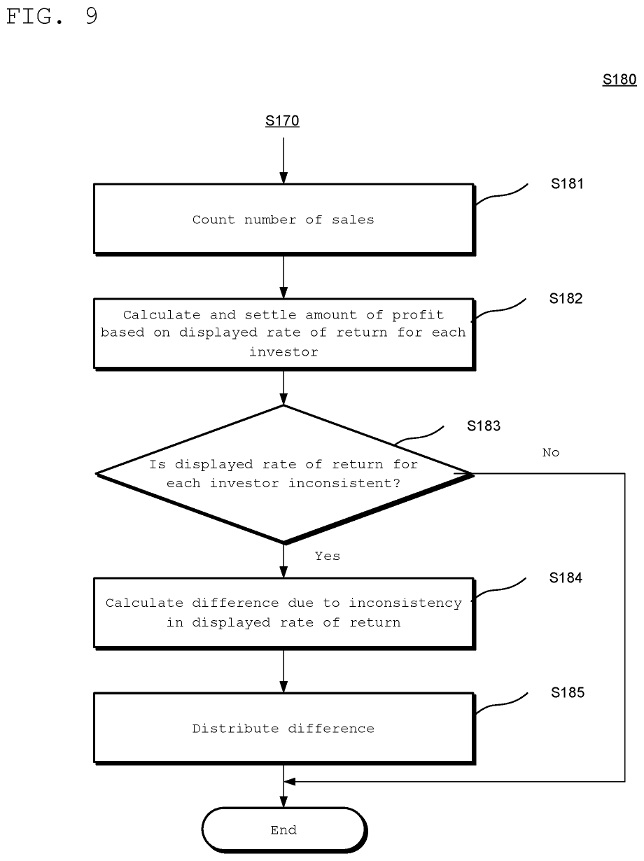

In step S180, the design crowdfunding system 10 may settle the amount of profit for crowdfunding. For example, the design crowdfunding server 100 may count a number of sales for a design product, calculate an amount of profit based on the number of sales and the displayed rate of return, and pay the calculated amount to the investor. The displayed rate of return may be calculated as the real-time rate of return at the time of funding or refunding by the investor. A detailed description of step S180 will be described later in FIG. 9.

FIG. 6 is a flowchart for explaining step S140 of FIG. 5. The investor recruitment operation according to step S140 may further include steps S141 to S145.

In step S141, the design crowdfunding system 10 may list design products available for investment. For example, the design crowdfunding server 100 may list images of design products for which funding has been initiated and expose them to the investor terminal 400. Specifically, images of design products for which funding has been initiated may be displayed on the investor terminal 400 in the following order: investment period closed, rate of return, product, total investment amount, total investors, and the like.

In step S142, the design crowdfunding system 10 may select a design product. For example, the design crowdfunding server 100 may select a design product to be funded based on a selection signal of the investor terminal 400. According to an embodiment, the design crowdfunding server 100 may calculate a real-time rate of return for the selected design product to provide the calculated information to the investor terminal 400.

In step S143, the design crowdfunding system 10 may receive an expected investment amount for the selected design product. For example, the design crowdfunding server 100 may receive the expected investment amount to be invested in the selected design product based on an input signal from the investor terminal 400.

In step S144, the design crowdfunding system 10 may calculate an expected rate of return based on the expected investment amount. For example, the design crowdfunding server 100 may add the expected investment amount to the total investment amount to date to calculate the expected rate of return using the total amount. For example, the expected rate of return may be calculated by dividing a value obtained by subtracting the production price from the sales price of the design product by the total amount.

In step S145, the design crowdfunding system 10 may receive an actual investment amount for the selected design product. For example, the design crowdfunding server 100 may receive the actual investment amount to be invested in the selected design product based on an input signal from the investor terminal 400. The investor may participate in crowdfunding for the selected design product by calculating the expected rate of return through steps S143 and S144 and entering the actual investment amount by referring thereto.

FIG. 7 is a flowchart for explaining step S150 of FIG. 5. The real-time return rate calculation operation according to step S150 may further include steps S151 to S158.

In step S151, the design crowdfunding system 10 may calculate a first real-time rate of return, and provide a first displayed rate of return. Here, the first real-time rate of return may be understood as a real-time rate of return for an existing investor before an additional investor is introduced. For example, the design crowdfunding server 100 may define investors who have participated in funding up to a first point in time, which is an arbitrary point in time, as existing investors based on the first point in time, and calculate a real-time rate of return at the first point in time as a first real-time rate of return. In addition, the design crowdfunding server 100 may provide the first displayed rate of return corresponding to the first real-time rate of return to the existing investor's terminal.

In step S152, the design crowdfunding system 10 may determine whether an additional investor has been introduced. For example, upon receiving an actual investment amount according to step S145 after the first point in time, the design crowdfunding server 100 may determine that an additional investor has been introduced. In step S152, the design crowdfunding system 10 may proceed to step S153 when it is determined that an additional investor has been introduced, and may return to step S151 when it is determined that no additional investor has been introduced.

In step S153, the design crowdfunding system 10 may calculate a second real-time rate of return, and provide a second displayed rate of return. For example, the design crowdfunding server 100 may calculate a real-time rate of return at a second point in time as a second real-time rate of return, based on the second point in time when an additional investor is introduced. In addition, the design crowdfunding server 100 may provide the second displayed rate of return corresponding to the second real-time rate of return to the additional investor's terminal.

In step S154, the design crowdfunding system 10 may calculate a return rate difference to determine whether the return rate difference is above a reference rate of return. Here, the return rate difference may be a difference between the first real-time rate of return and the second real-time rate of return or a difference between the first displayed rate of return and the second displayed rate of return. For example, the design crowdfunding server 100 may proceed to S155 when it is determined that the return rate difference is above a reference rate of return, and may proceed to step S158 when it is determined that the return rate difference is below the reference rate of return.

According to an embodiment, the reference rate of return is set differently depending on the return rate section, and the reference rate of return may increase as the rate of return increases. For example, the return rate section may include a first section with a rate of return above 100%, a second section with a rate of return above 10% and below 100%, a third section with a rate of return above 1% and below 10%, a fourth section with a rate of return above 0.1% and below 1%, a fifth section with a rate of return above 0.01% and below 0.1%, and a sixth section with a rate of return below 0.01%. For example, a reference rate of return in the first section may be set to 100%, a reference rate of return in the second section to 10%, a reference rate of return in the third section to 1%, a reference rate of return in the fourth section to 0.1%, a reference rate of return in the fifth section to 0.01%, and a reference rate of return in the sixth section to 0.001%.

In step S155, the design crowdfunding system 10 may inquire of the existing investor about whether to refund when the return rate difference is above the reference rate of return. For example, in the first section, the design crowdfunding server 100 may provide the investor terminal 400 with a selection message regarding whether to refund the investment amount when the return rate difference is above 100%. According to an embodiment, the design crowdfunding server 100 may inquire of the existing investor about whether to refund whenever decreased by the reference rate of return for each section.

According to an embodiment, the inquiry about whether to refund may be delayed because the rate of return fluctuates significantly during a specific period shortly after the crowdfunding is initiated. For example, the inquiry about whether to refund may be delayed for one week after the initiation of funding. According to an embodiment, during the specific period, whenever decreased by 2 to 5 times the reference rate of return for each section, the existing investor may be inquired about whether to refund. For example, in the first section, the design crowdfunding server 100 may provide the investor terminal 400 with a selection message regarding whether to refund the investment amount when the return rate difference is above 50%, which is 5 times the reference rate of return of 10% in the second section.

In step S156, the design crowdfunding system 10 may determine whether to refund in response to the inquiry about whether to refund. For example, upon receiving a refund request signal from the existing investor's terminal in response to the inquiry about whether to refund, the design crowdfunding server 100 may refund a predetermined amount of the investment amount to the existing investor and proceed with step S157. For example, upon receiving a refund non-request signal from the existing investor's terminal in response to the inquiry about whether to refund, the design crowdfunding server 100 may proceed with step S158.

In step S157, the design crowdfunding system 10 may calculate a third real-time rate of return in response to the refund request signal, and provide a third displayed rate of return to the existing investor. For example, the design crowdfunding server 100 may calculate the third real-time rate of return based on a total investment amount excluding the refund amount.

In addition, the design crowdfunding system 10 may provide the third displayed rate of return corresponding to the third real-time rate of return to the existing investor's terminal. For example, in response to a refund request signal, the design crowdfunding server 100 may update the first displayed rate of return to the third displayed rate of return corresponding to the third real-time rate of return to provide the updated information to the existing investor's terminal.

According to an embodiment, the third displayed rate of return may be the same as the first displayed rate of return. In this case, the refund amount may be an amount obtained by deducting a commission fee from the investment amount corresponding to a difference between the first displayed rate of return and the second displayed rate of return.

According to an embodiment, the third displayed rate of return may be higher than the second displayed rate of return and lower than the first displayed rate of return. In this case, the refund amount may be an amount obtained by deducting a commission fee from the investment amount corresponding to a difference between the second displayed rate of return and the third displayed rate of return.

In step S158, the design crowdfunding system 10 may maintain a second real-time rate of return in response to a refund non-request signal, and provide a second displayed rate of return to the existing investor. For example, in response to a refund non-request signal, the design crowdfunding server 100 may update the first displayed rate of return to the second displayed rate of return corresponding to the second real-time rate of return to provide the updated information to the existing investor's terminal.

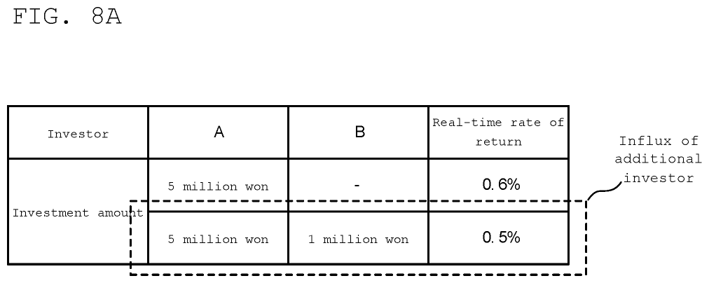

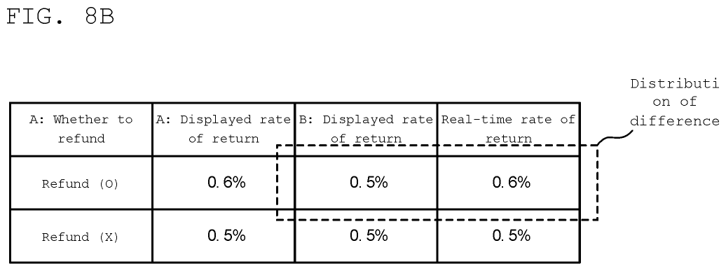

FIGS. 8A and 8B are examples for explaining when an additional investor is introduced in step S152 of FIG. 7. For convenience of explanation, it is assumed that a value obtained by subtracting the production price from the sales price is 30,000 won. In FIGS. 8A and 8B, investor A may be an existing investor and investor B may be an additional investor.

Referring to FIG. 8A, in a state where the investor A invests 5 million won in a design product, the real-time rate of return may be 0.6%, which is a percentage of 30,000 won, which is a value obtained by subtracting the production price from the sales price, divided by the total investment amount of 5 million won. In this case, a first real-time rate of return and a first displayed rate of return are 0.6%.

Here, if the investor B funds in the same design product with an investment amount of 1 million won, then the real-time rate of return may be 0.5%, which is a percentage of 30,000 won, which is a value obtained by subtracting the production price from the sales price, divided by the total investment amount of 6 million won. In this case, a second real-time rate of return and a second displayed rate of return are 0.5%.

Here, a return rate section may be a fourth section according to step S154, and a reference rate of return may be 0.1%. If so, a difference between a first real-time rate of return and a second real-time rate of return is above the reference rate of return, and the design crowdfunding server 100 may provide a refund opportunity to the investor A.

FIG. 8B shows a difference in displayed rates of return depending on when the investor A refunds and when he or she does not refund. Referring to FIG. 8B, when the investor A does not refund, the real-time rates of return for the investor A and the investor B may be 0.5%, which is a second real-time rate of return. The design crowdfunding server 100 may update a first displayed rate of return to a second displayed rate of return to provide the updated information to the investor A's terminal.

When the investor A refunds, real-time rates of return for the investor A and the investor B may be 0.6%, which is a third real-time rate of return. The refund amount may be an amount corresponding to an investment amount of the investor B, and a third real-time rate of return may be the same as the first real-time rate of return. The design crowdfunding server 100 may update a first displayed rate of return to a third displayed rate of return to provide the updated information to the investor A's terminal. The third displayed rate of return may correspond to the third real-time rate of return. In this case, a second displayed rate of return may be maintained at 0.5%.

In this way, an inconsistency may occur between the third displayed rate of return of the investor A and the second displayed rate of return of the investor B, and the design crowdfunding server 100 may determine whether to refund by determining an inconsistency in the displayed rates of return between the investors. During the settlement of an amount of profit, the design crowdfunding server 100 may calculate a difference between the third real-time rate of return of 0.6% and the investor B's second displayed rate of return of 0.5% to distribute the difference. According to an embodiment, the design crowdfunding server 100 may be configured to distribute the difference to at least one of a designer, a producer, an investor, and an operator according to a distribution policy.

FIG. 9 is a flowchart for explaining step S180 of FIG. 5. The settlement operation according to step S180 may further include steps S181 to S185. Referring to FIG. 9, in step S181, the design crowdfunding system 10 can count a number of sales of a design product. For example, the design crowdfunding server 100 may count a number of sales of a design product purchased through the consumer terminal 500 to use the counted number for the settlement of the amount of profit.

In step S182, the design crowdfunding system 10 may calculate and settle the amount of profit based on a displayed rate of return for each investor. For example, the design crowdfunding server 100 may calculate the amount of profit by multiplying a value obtained by multiplying the sales price of a design product by the counted number of sales by the displayed rate of return and further multiplying it by a value obtained by dividing an investment amount for each investor by a total investment amount. The design crowdfunding server 100 may settle the amount of profit by paying the calculated amount of profit to the investor.

In step S183, the design crowdfunding system 10 may determine whether the displayed rate of return for each investor is inconsistent. For example, the design crowdfunding server 100 may determine whether the displayed rate of return of an existing investor and the displayed rate of return of an additional investor are the same. When a refund of the existing investor's investment amount occurs due to the influx of an additional investor, the displayed rate of return of the existing investor and the displayed rate of return of the additional investor may be inconsistent, as shown in FIG. 8B. Since the total investment amount is reduced by the refund, the real-time rate of return increases, but the displayed rate of return for the additional investor is maintained, so in this case, a problem with distribution of the difference may occur.

According to an embodiment, when the displayed rate of return for each investor is consistent, the design crowdfunding server 100 may determine that there has been no request for a refund from the existing investor, and complete the settlement of the amount of profit. If there is no refund request from an existing investor, then the real-time rate of return and displayed rate of return including the investment amount of an additional investor may be calculated, and the displayed rate of return for the existing investor may be updated based thereon, and therefore, the displayed rate of return for each investor may be consistent.

In step S184, the design crowdfunding system 10 may calculate a difference due to an inconsistency in the displayed rate of return for each investor. For example, the design crowdfunding server 100 may calculate a maximum amount of profit based on the highest displayed rate of return among the displayed returns for each investor, and calculate the difference as an amount obtained by subtracting an amount of profit paid based on the displayed rate of return for each investor from the maximum amount of profit. For example, the design crowdfunding server 100 may calculate the maximum amount of profit by multiplying a value obtained by multiplying the sales price of a design product by the counted number of sales by the maximum displayed rate of return and further multiplying it by a value obtained by dividing an investment amount for each investor by a total investment amount.

In step S185, the design crowdfunding system 10 may distribute the calculated difference. For example, the design crowdfunding server 100 may distribute the calculated difference to at least one of a designer, a producer, an investor, and an operator according to a set distribution policy. For example, the distribution policy may be performed by distributing a predetermined amount of the difference to a designer. For example, the distribution policy may be performed by distributing a predetermined amount of the difference to an existing investor or an additional investor. For example, the distribution policy may be performed by distributing a predetermined amount of the difference to an operator of the design crowdfunding server 100. It is apparent that the distribution policy is not limited thereto and may vary depending on the embodiment.

Meanwhile, various embodiments described in this specification may be implemented by hardware, middleware, micro-codes, software, and/or a combination thereof. For example, various embodiments may be implemented by one or more application specific integrated circuits (ASICs), digital signal processors (DSPs), digital signal processing devices (DSPDs), programmable logic devices (PLDs), and field programmable gate arrays (FPGAs), processors, controllers, microcontrollers, microprocessors, other electronic units designed to perform functions presented herein, or a combination thereof.

In addition, for example, various embodiments may be recorded or encoded in a computer-readable medium including commands. The commands recorded or encoded in a computer-readable medium may cause a programmable processor or other processors to perform a method, for example, when the commands are executed. The computer-readable medium includes a computer storage medium, which may be any available medium that can be accessed by a computer. For example, such a computer-readable medium may include RAM, ROM, EEPROM, CD-ROM or other optical disk storage media, magnetic disk storage media or other magnetic storage devices.

The hardware, software, firmware, and the like may be implemented in the same device or in individual devices to support various operations and functions described herein. Additionally, elements, units, modules, components, and the like described as a “˜ unit” in the present disclosure may be implemented together or individually as logic devices interoperable while being individual. The description of different features for modules, units, or the like is intended to highlight different functional embodiments and does not necessarily denote that the embodiments must be realized by individual hardware or software components.

Although operations are shown in the drawings in a specific order, it should not be understood that these operations do not need to be performed in a specific order or a sequential order shown in the drawings or all the operations shown in the drawings do not need to be performed to accomplish a desired result. In a certain environment, multitasking and parallel processing may be advantageous. Moreover, it should be understood that classification of various elements in the foregoing embodiments is not needed in all embodiments, and the described elements may be generally integrated together as a single software product or packaged into a plurality of software products.

As described above, various embodiments have been disclosed in the drawings and specification. Although specific terms are used herein, they are used only for the purpose of explaining the present disclosure and are not used to limit the meaning or scope of the present disclosure described in the claims. Therefore, it should be understood by those skilled in the art that various modifications and equivalent other embodiments of the present disclosure can be made. Consequently, the true technical protective scope of the present disclosure should be determined based on the technical concept of the appended claims.

What is claimed is:

1. A method of providing a design crowdfunding service for a design product in a design crowdfunding system, the method comprising:
initiating crowdfunding by exposing an image of the design product;
setting an investment period for the design product;
recruiting an investor by providing an expected rate of return and a real-time rate of return during the investment period; and
settling, after the investment period has elapsed, an amount of profit for the crowdfunding based on a number of sales and a displayed rate of return for the design product,
wherein the real-time rate of return is calculated by dividing a value obtained by subtracting a production price from a sales price of the design product by a total investment amount of the existing investor,
wherein the expected rate of return is calculated by dividing a value obtained by subtracting the production price from the sales price of the design product by a sum of the total investment amount and an expected investment amount of an additional investor, and
wherein the displayed rate of return is calculated as the real-time rate of return at the time of funding or refunding by the investor.

2. The method of claim 1, wherein the recruiting of the investor further comprises:
calculating a first real-time rate of return according to the influx of the existing investor, and providing a first displayed rate of return corresponding to the first real-time rate of return to the existing investor's terminal;
receiving the expected investment amount of the additional investor to calculate the expected rate of return;
calculating a second real-time rate of return according to an additional influx of the additional investor, and providing a second displayed rate of return corresponding to the second real-time rate of return to the additional investor's terminal; and
inquiring, when a difference between the first real-time rate of return and the second real-time rate of return is above a reference rate of return for each section, about whether to refund the existing investor's investment amount through the existing investor's terminal.

3. The method of claim 2, wherein the reference rate of return for each section is set differently according to a plurality of rate of return sections to increase as an average rate of return of the plurality of rate of return sections increases.

4. The method of claim 2, wherein the recruiting of the investor further comprises:
refunding, when a refund request signal is received from the existing investor's terminal in response to the inquiry about whether to refund, a predetermined amount of the existing investor's investment amount, and calculating a third real-time rate of return based on the total investment amount excluding the refund amount; and
maintaining, when a refund non-request signal is received from the existing investor's terminal in response to the inquiry about whether to refund, the second real-time rate of return.

5. The method of claim 4, wherein the recruiting of the investor further comprises:
updating, in response to the refund request signal, the first displayed rate of return to a third displayed rate of return corresponding to the third real-time rate of return to provide the updated third real-time rate of return to the existing investor's terminal; and
updating, in response to the refund non-request signal, the first displayed rate of return to the second displayed rate of return corresponding to the second real-time rate of return to provide the updated second displayed rate of return to the existing investor's terminal.

6. The method of claim 5, wherein the third displayed rate of return is equal to the first displayed rate of return, or is higher than the second displayed rate of return and is lower than the first displayed rate of return.

7. The method of claim 1, wherein the settling of the amount of profit further comprises:
counting the number of sales of the design product;
calculating the amount of profit through multiplying a value obtained by multiplying the sales price of the design product by the number of sales by the displayed rate of return, and further multiplying by a value obtained by dividing the investment amount for each investor by the total investment amount; and
paying the amount of profit for each of investor.

8. The method of claim 7, wherein the settling of the amount of profit further comprises:
checking whether the displayed rate of return for each investor is inconsistent;
calculating, when the displayed rate of return for each investor is inconsistent, a difference due to an inconsistency in the displayed rate of return; and
distributing the difference to at least one of a designer, a producer, an investor, and an operator according to a set distribution policy.

9. The method of claim 8, wherein the calculating of the difference further comprises:
calculating a maximum amount of profit based on the highest maximum displayed rate of return among the displayed rates of return for each investor; and
subtracting the amount of profit that has been paid based on the displayed rate of return for each investor from the maximum amount of profit.

10. The method of claim 8, wherein the settling of the amount of profit further comprises determining that there has been no request for a refund from the existing investor when the displayed rate of return for each investor is consistent, and completing the settlement of the amount of profit.
